(19) United States
(12) Patent Application Publication
(10) Pub. No.: US 2011/0016175 A1
(43) Pub. Date: Jan. 20, 2011

(54) METHOD FOR REALIZATION OF THIN CLIENT AND CLIENT TERMINAL AND SERVER FOR SAME

(75) Inventors: Madoka Mitsuoka, Kawasaki (JP); Masatomo Yasaki, Kawasaki (JP); Shunsuke Yamaguchi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/888,588

(22) Filed: Sep. 23, 2010

Related U.S. Application Data
(63) Continuation of application No. PCT/JP2008/056398, filed on Mar. 31, 2008.

(51) Int. Cl. G06F 15/16

(52) U.S. Cl. 709/203

(57) ABSTRACT

A method for realization of a thin client includes detecting a usage environment of a client terminal, using the detected usage environment and a predetermined policy to determine whether to realize the thin client as a screen transfer type or by a net boot type, when the screen transfer type is determined, transferring input made at the client terminal to a server and transferring results of processing by the server in accordance with the input from the server to the client terminal, and, when the net boot type is determined, transferring a program from the server to the client terminal, the program outputting results of processing at the client terminal in accordance with input from the client terminal.

### CROSS-REFERENCE TO RELATED APPLICATION

This application is a continuation application based upon International Application No. PCT/JP2008/056398, filed on Mar. 31, 2008, the contents being incorporated herein by reference.

### FIELD

The present invention relates to a method of realization of a thin client system and to a client terminal and server for the same.

### BACKGROUND

To facilitate the central control of client side computer environments at a server side and prevent the leakage of confidential information due to loss of computers, thin client systems are being increasingly introduced. Thin client systems are using computers having simplified hardware configurations such as not having external storage devices at the client side.

The schemes for realization of thin client systems are roughly classified into two types: the screen transfer type and the net boot type. The screen transfer type prepares the client side environment for running the basic software and application software (hereinafter simply referred to as the “working environment”) and data at the server side, runs a processing at a server side computer (hereinafter simply referred to as a “server”), and just has the computer serving as the client side terminal (hereinafter referred to as a “client terminal) display the screen transferred from the server and receive input of data for the server. The net boot type downloads the client side working environment from the server to the client terminal and starts up the client terminal. In both systems, data files produced and changed by the user are stored at the server side. These systems have their respective advantages and disadvantages.

The advantages of the screen transfer type are that the functions for the client terminal are low and use is possible at some mobile phones and PDAs (Personal Digital Assistants) as well. The disadvantages are that due to the network delay at the time of transfer of screen data and transmission of input, the response falls in applications using much graphics and that a large size server is desirable for the working environment.

The advantage of the net boot type is that the performance at the time of use is close to that of an existing computer environment having a hard disk. The disadvantage is that a network band is relatively large at the time of startup. Dealing with mobile phones, PDAs, and other different types of hardware and different types of operating systems was also relatively difficult.

In general, when a user connects a client terminal to a network run by an Internet connection service or other party (hereinafter simply referred to as an “outside network”) to access from the outside an in-house network to which the user belongs (hereinafter referred to as “mobile use”), the screen transfer type is suitable. When a user connects a client terminal to a local area network, that is, an in-house network to which the user belongs, for use of the same (hereinafter referred to as “in-house use”), the net boot type is suitable. However, in the past, when selecting one of these systems, inconveniences occurred in either mobile use or in-house use. Further, when preparing different systems to enable the user to select from the two systems in accordance with the objective of mobile use or in-house use, an increase in cost of the terminals, server, and software licenses was invited. Further, there was the inconvenience of the user side having to selectively use the different computer environments.

PLT 1: Japanese Patent No. 3397166

PLT 2: Japanese Laid-Open Patent Publication No. 63-244157

### SUMMARY

According to the present embodiments, there is provided a method for realization of a thin client comprising detecting a usage environment of a client terminal, using the detected usage environment and a predetermined policy to determine whether to realize the thin client as a screen transfer type or by a net boot type, when the screen transfer type is determined, transferring input made at the client terminal to a server and transferring results of processing by the server in accordance with the input from the server to the client terminal, and, when the net boot type is determined, transferring a program from the server to the client terminal, the program outputting results of processing at the client terminal in accordance with input from the client terminal.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a first example of the configuration of a thin client system according to an embodiment.

FIG. 2 is a block diagram illustrating the software modules included in the servers 14, 16, and 18 and terminals 10 of FIG. 1 and the relationship among them.

FIG. 3 is a sequence diagram of the case where the net boot type is selected in the constitution of FIG. 2.

FIG. 4 is a sequence diagram of the case where the screen transfer type is selected in the constitution of FIG. 2.

FIG. 5 is a view illustrating a second example of the configuration of a thin client system according to an embodiment.

FIG. 6 is a block diagram illustrating the software modules included in the servers 14, 16 and terminal 10′ of FIG. 5 and the relationship between them.

FIG. 7 is a sequence diagram of the case where the net boot type is selected in the constitution of FIG. 6.

FIG. 8 is a sequence diagram of the case where the screen transfer type is selected in the constitution of FIG. 6.

### DESCRIPTION OF EMBODIMENTS

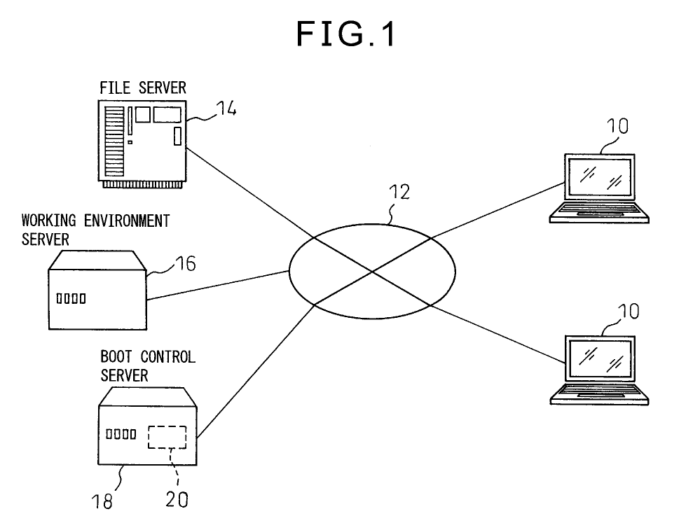

FIG. 1 illustrates an example of the configuration of a thin client system according to an embodiment of the present invention.

In FIG. 1, a terminal 10 not having a hard disk or other external storage device (thin client) is connected through an in-house LAN, mobile phone network, the Internet, or other network 12 to a file server 14, working environment server 16, and boot control server 18. The file server 14 stores a boot image of the computer environment of each user. The working environment server 16 realizes the computer environment of the user at the server side so as to realize a screen transfer type thin client for the user. The boot control server 18 has a boot control module 20. The boot control module 20 determines based on the environment in which the terminal 10 is placed whether to use the terminal 10 as the screen transfer type or the net boot type, that is, determines whether to load the boot image in the file server 14 to the working environment server 16 or to load the boot image in the terminal 10. The boot control module 20 notifies the determinated result to the working environment server 16 or terminal 10. The boot control module 20 can also physically operate on the file server 14 or the working environment server 16. In this case, it is not necessary to independently provide the boot control server 18. Furthermore, it is also possible to realize the file server 14 and working environment server 16 physically by a single server.

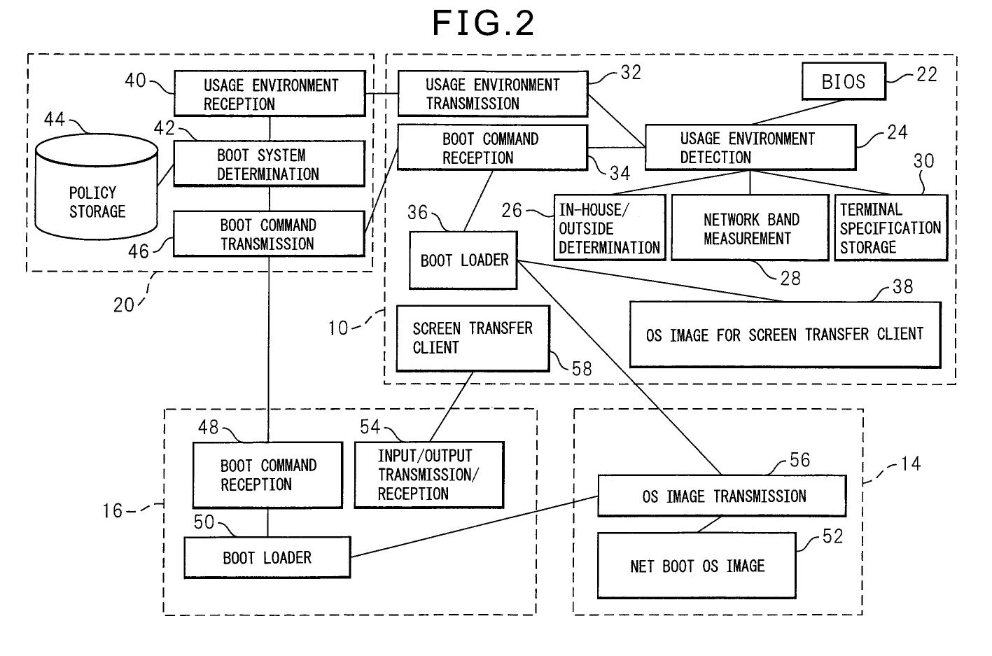

FIG. 2 illustrates software modules included in the servers 14, 16, and 18 and the terminals 10 illustrated in FIG. 1 and the relationship among the software modules.

Each terminal 10 has a BIOS (Basic Input/Output System) 22 first operating at the time of startup. A terminal environment detection unit 24 is called up from the BIOS 22 and detects the environment in which the terminal 10 is placed (hereinafter referred to as a “usage environment”). The usage environment, for example, includes outside/in-house, the network band, the terminal specifications and type. An outside/in-house determination unit 26, network band measurement unit 28, and terminal specification storage unit 30 are modules for detecting the usage environment utilized by the usage environment detection unit 24. The usage environment transmission unit 32 transmits the detected usage environment to the boot control module 20. The boot command reception unit 34 receives a boot command from the boot control module 20. According to the boot command, the boot loader 36 starts up an OS (operating system) image 38 for a screen transfer client stored in the terminal 10. Otherwise the boot loader communicates with the file server 14 and downloads and starts up an OS image 52 for a net boot. The OS image is a copy of the content of the storage device when the OS is installed in the computer or when the OS and an application program used by the user are installed.

The usage environment reception unit 40 of the boot control module 20 receives the usage environment from the usage environment transmission unit 32 of the terminal 10. The boot system determination unit 42 refers to a policy storage unit 44 in which is stored a policy for determination of the boot system in accordance with the detected usage environment and determines the boot system in accordance with the policy. The boot command transmission unit 46 notifies a command of the boot system determined by the boot system determination unit 42 to the terminal 10 or working environment server 16.

The boot command reception unit 48 of the working environment server 16 receives a command of the boot system from the boot command transmission unit 46 of the boot control module 2, then the boot loader 50 downloads and stores the OS image for the net boot stored in the file server 14. The working environment server 16 further has an input/output transmission unit 54, sends data of the screen output by the started up working environment to the terminal 10, and receives inputs from the terminal 10.

The file server 14 has an OS transmission unit 56 which receives requests from the terminal 10 or working environment server 16 and transmits an OS image 52 for net boot.

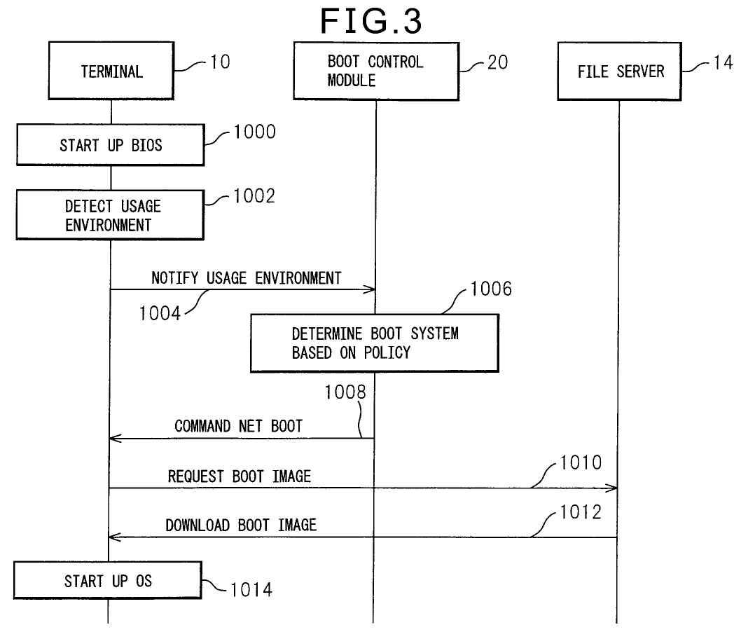

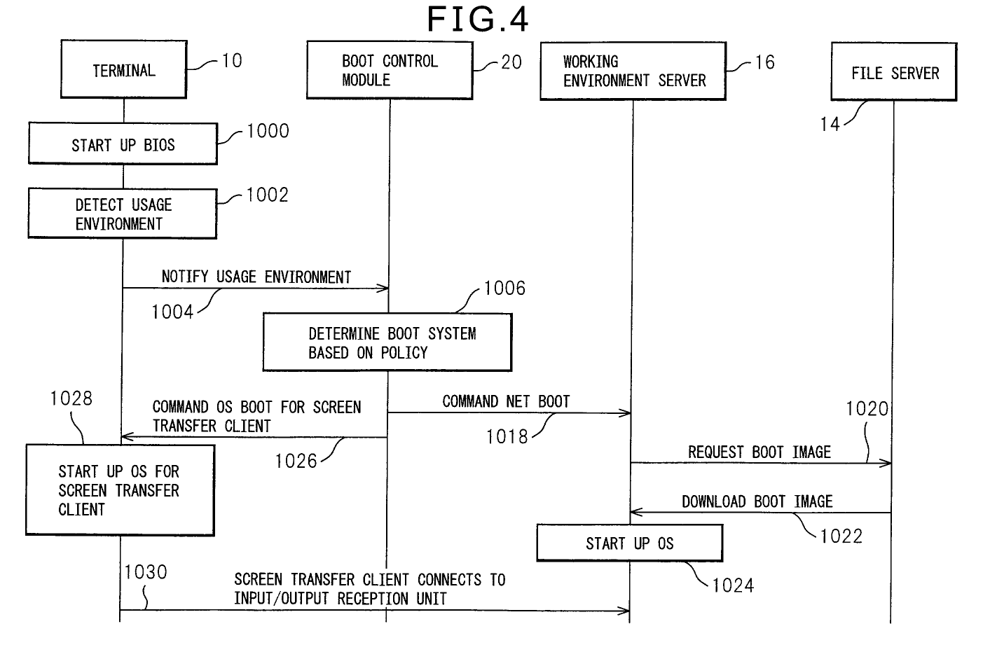

Next, referring to FIG. 2 and to the sequence diagrams of FIG. 3 and FIG. 4, the flow of processing in the present embodiment when the terminal 10 is started up will be explained.

1) When the terminal 10 is powered up, a BIOS program 22 recorded in the terminal 10 is started up (FIG. 3, FIG. 4: step 1000).

2) The BIOS program 22 starts up the usage environment detection unit 24. The usage environment detection unit 24 uses the outside/in-house determination unit 26, network band measurement unit 28, and terminal specification storage unit 30 to detect the usage environment (step 1002).

More specifically, the outside/in-house determination unit 26 utilizes the IP address automatic acquisition protocol DHCP (Dynamic Host Configuration Protocol) and connects to the DHCP server (not illustrated). The DHCP server transmits, in addition to the IP address and other information, authentication information of the server to the outside/in-house determination unit 26. The outside/in-house determination unit 26 utilizes the authentication information of the in-house network registered in advance and the authentication information obtained from the DHCP server to determine if the DHCP server is in-house or not and thereby determines which network the terminal is connected to or if it is connected to an in-house network.

The network band measurement unit 28 uses the result of determination of the outside/in-house determination unit 26 to determine the band measurement server (not illustrated) registered in the network band measurement unit 28 in accordance with the network to which the terminal 10 is connected. Then the network band measurement unit 28 connects with the determined band measurement server and transmits dummy data for band measurement. It measures the time for transfer of data with the band measurement server and calculates the network band.

The terminal specifications are registered in advance in the terminal specification storage unit 30. The terminal specifications can include the name and type of the model (notebook PC, PDA, mobile phone, etc.) and information as to if the terminal is registered for company use or is a personal use terminal. In general, in the case of a personal use terminal, the high security screen transfer type is suitable.

3) The terminal environment transmission unit 32 transmits the detected environment to the boot control module 20 through the network 12 (step 1004).

4) The usage environment reception unit 40 of the boot control module 20 receives the usage environment detected by the terminal 10. The policy storage unit 44 registers in advance the policy for determining the boot system in accordance with the detected usage environment. The boot system determination unit 42 determines the boot system (net boot or screen transfer) in accordance with the detected usage environment and policy registered in the policy storage unit 44 (step 1006).

Below, as one description example of the policy will be given. According to the example of the following policy, a net boot is performed in the case of an in-house registered notebook PC or the case of a registered notebook PC connected to an outside network with a band of 5 Mbps or more and the screen transfer system is used in other cases.

IF ((type of network=in-house) AND (type of terminal=notebook PC) AND (terminal registered=YES))

OR ((type of network=outside) AND (network band>5 Mbps) AND (type of terminal=notebook PC) AND (terminal registered=YES))

THEN net boot ELSE screen transfer

Step 1008 on of FIG. 3 illustrates the sequence in the case of a net boot being selected, while step 1018 on of FIG. 4 illustrates the sequence in the case of a screen transfer being selected. In the case of a net boot determined at FIG. 3,

5) the boot command transmission unit 46 of the boot control module 20 commands a net boot to the terminal 10 and transmits the URL of the file server for download of the boot image (step 1008).

6) When the boot command reception unit 34 of the terminal 10 receives a net boot command, a boot image is requested using the HTTP protocol from the file server 14 of the URL commanded by the boot loader 36 (step 1010). The file server 14 utilizes digest authentication, SSL authentication, or another authentication system generally used on the HTTP for authentication of the terminal 10.

7) The OS image transmission unit 56 of the file server 14 receives a request from the terminal 10 and transmits a net boot OS image 52 stored for each user and terminal to the terminal (step 1012).

8) The boot loader 36 of the terminal 10 utilizes the downloaded OS image to start up the OS (step 1014).

In the case of selection of screen transfer of FIG. 4,

9) the boot command transmission unit 46 of the boot control module 20 commands a net boot to the working environment server 16 and transmits the URL of the file server for download of the boot image (step 1018).

10) When the boot command reception unit 48 of the working environment server 16 receives a boot command, a boot image is requested using the HTTP protocol from the file server 14 of the URL commanded by the boot loader 36 (step 1020). The file server 14 utilizes digest authentication, SSL authentication, or another authentication system generally used on the HTTP for authentication of the working environment server 16.

11) The OS image transmission unit 56 of the file server 14 receives a request from the working environment server 16 and transmits a net boot OS image 52 stored for each user to the working environment server 16 (step 1022).

12) The boot loader 50 of the working environment server 16 utilizes the downloaded OS image to start up the OS (step 1024).

13) On the other hand, the boot command transmission unit 46 of the boot control module 20 commands an OS boot for a screen transfer client to the terminal 10 (step 1026).

14) When the boot command reception unit 34 of the terminal 10 receives a command for an OS boot for a screen transfer client, the boot loader 36 starts up the OS 38 for a screen transfer client stored in the terminal 10 (step 1028).

15) Next, the terminal 10 starts up the screen transfer client 58 and connects to the input/output transmission/reception unit 54 of the working environment server 16 (step 1030).

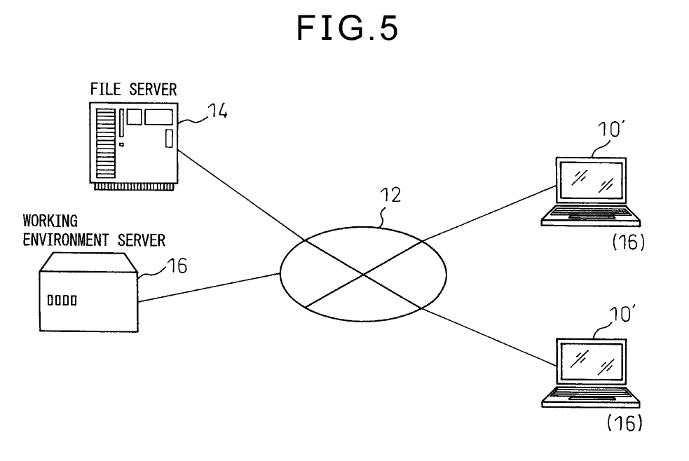

FIG. 5 illustrates a second example of the configuration of a thin client system according to an embodiment of the present invention.

In the example illustrated in FIG. 5, a boot control module 16 determining and commanding the boot system is provided inside the terminal 10′, so there is no need to provide a boot control server. The rest of the configuration is similar to the example of FIG. 1.

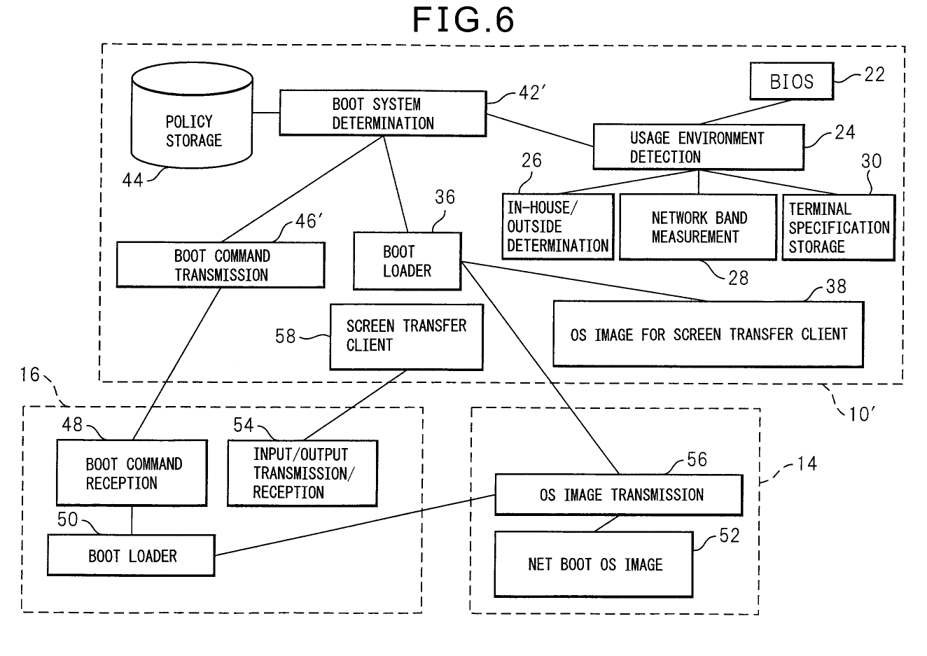

FIG. 6 illustrates the software modules included in the servers 14, 16 and the terminals 10′ illustrated in FIG. 5 and the relationship among the software modules. The module 16 having the same function as in FIG. 2 is assigned the same reference numeral.

Each terminal 10′ has a BIOS 22 first operating at the time of startup. A usage environment detection unit 24 is called up from the BIOS 22 and detects the environment in which the terminal is placed. An outside/in-house determination unit 26, network band measurement unit 28, and terminal specification storage unit 30 are modules for detecting the usage environment utilized by the usage environment detection unit 24. The usage environment detection unit 24 notifies the detected usage environment to the boot system determination unit 42′. The boot system determination unit 42′ refers to the policy storage unit 44 in which the policy for determination of the boot system is stored, determines the boot system in accordance with the policy, and gives a boot command to the boot loader 36 or boot command transmission unit 46′. In accordance with the boot command, the boot loader 36 starts up the OS image 38 for a screen transfer client stored in the terminal 10′ or communicates with the file server 14 and downloads and starts up the OS image 52 for net boot. The boot command transmission unit 46′ communicates with the working environment server 16 and transmits a boot command.

Regarding the working environment server 16, the boot command reception unit 48 receives a command of the boot system from the boot command transmission unit 46′ of the boot control module of the terminal 10′. Otherwise, the configuration is similar to the above first example.

The file server 14 is configured in the same way as the file server 14 in the first example.

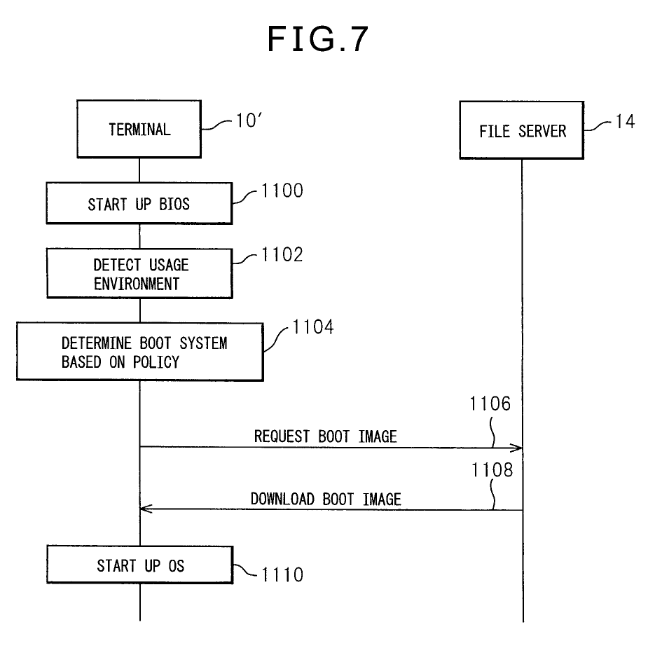

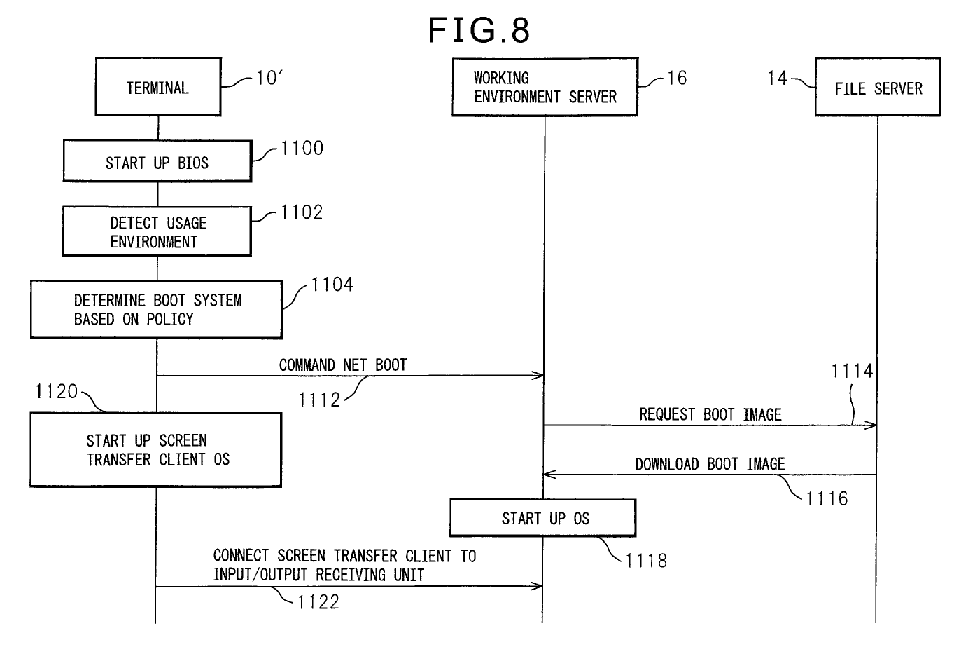

Next, the flow of processing in the case where a terminal is started up in the example illustrated in FIG. 5 and FIG. 6 will be explained with reference to the sequence diagrams of FIG. 7 and FIG. 8.

1) When the terminal 10′ is powered up, a BIOS program 22 recorded in the terminal 10′ is started up (FIG. 7, FIG. 8: step 11000).

2) The BIOS program 22 starts up the usage environment detection unit 24. The usage environment detection unit 24 uses the outside/in-house determination unit 26, network band measurement unit 28, and terminal specification storage unit 30 to detect the usage environment (FIG. 7, FIG. 8: step 1102). These operations are similar to those explained in the first example above.

3) In accordance with a policy, registered in advance by the user in the policy storage unit 40 and determining the boot system in accordance with the usage environment, the boot system determination unit 42′ determines the boot system (net boot or screen transfer) (step 1104). The content and operation of the policy are similar to the first example.

In the case where the net boot is selected in FIG. 7,

4) the boot command system determination unit 42′ of the terminal 10′ commands a net boot to the boot loader 36 and designates the URL of the file server for download of the boot image (step 1106).

5) A boot image is requested using the HTTP protocol from the file server 14 of the URL commanded by the boot loader 36 (step 1106). The file server 14 utilizes digest authentication, SSL authentication, or other generally used authentication systems on the HTTP so as to authenticate the terminal 10′.

6) The OS image transmission unit 56 of the file server 14 receives a request from the terminal 10′ and transmits a net boot OS image 52 stored for each user and terminal to the terminal (step 1108).

7) The boot loader 36 of the terminal utilizes the downloaded OS image to start up the OS (step 1110).

In the case of selection of screen transfer of FIG. 8,

8) the boot command transmission unit 46′ of the terminal 10′ commands a net boot to the working environment server 16 and transmits the URL of the file server for download of the boot image (step 1112).

9) When the boot command reception unit 48 of the working environment server 16 receives a boot command, a boot image is requested using the HTTP protocol from the file server 14 of the URL commanded by the boot loader 50 (step 1114). The file server 14 utilizes digest authentication, SSL authentication, or another authentication system generally used on the HTTP for authentication of the working environment server 16.

10) The OS image transmission unit 56 of the file server 14 receives a request from the working environment server 16 and transmits a net boot OS image 52 stored for each user to the working environment server 16 (step 1116).

11) The boot loader 50 of the working environment server 16 utilizes the downloaded OS image to start up the OS (step 1118).

12) On the other hand, the boot system determination unit 42′ of the terminal 10′ commands an OS boot for a screen transfer client to the boot loader 36.

13) The boot loader 36 of the terminal 10′ starts up the OS 38 for a screen transfer client stored in the terminal 10′ (step 1120).

14) Next, the terminal 10′ starts up the screen transfer client 58 and connects to the input/output transmission unit/reception unit 54 of the working environment server 16 (step 1122).

In the first example explained above, the policy was stored and decisions were made based on this together at the server side (boot control server), but in the second example, these were managed at the terminal side, so the degree of freedom at the user side is high.

According to the embodiments, when taking a terminal outside an office or when otherwise mobile, the terminal is started up by the screen transfer system, so at the time of startup, the load placed on the network greatly falls compare with the net boot system. Further, in an in-house LAN or other environment where the load at the time of startup does not become a major issue, the net boot system is used for startup, so good operability can be realized compared with the screen transfer system where operation is delayed. Furthermore, in the screen transfer type, a working environment server for all terminals, including in-house ones, is needed, but in the present embodiments, it is sufficient to prepare a working environment server for the terminals utilized taken out to a mobile environment. The cost at the server side is therefore cut.

Compared with the case of introducing separate client systems of the screen transfer system and net boot system for mobile and for in-house use, the cost of the system as a whole is slashed. For the user, a common working environment can be utilized in both cases, so the user friendliness is improved compared with the existing art where the environment has to be selectively utilized.

The usage environment in which the client terminal is placed and a predetermined policy are used as the basis for selection of either the screen transfer type or the net boot type—each of which has its advantages and disadvantages, so it is possible to automatically select the optimal system for realization of a thin client for the usage environment in which the terminal is placed. Further, there is no need to prepare a screen transfer type working environment for all client terminals, so the cost is low.

Furthermore, by making the boot image used at both methods of realization the same image, from the user's viewpoint, it is possible to use the same working environment no matter what the case, so the user friendliness is improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A method for realization of a thin client comprising:
detecting a usage environment of a client terminal;
using the detected usage environment and a predetermined policy to determine whether to realize the thin client as a screen transfer type or a net boot type;
when the screen transfer type is determined, transferring input made at the client terminal to a server and transferring results of processing by the server in accordance with the input from the server to the client terminal; and
when the net boot type is determined, transferring a program from the server to the client terminal, the program outputting results of processing at the client terminal in accordance with input from the client terminal.

2. The method according to claim 1 further comprising:
storing a program for outputting results of processing in accordance with input from the client terminal in the server in the form of a boot image for each user;
when the net boot type, the transferring the program from the server to the client terminal including transferring the boot image stored for the user from the server to the client terminal; and
when the screen transfer type, further comprising transferring the boot image stored for the user to a working environment in the server.

3. The method according to claim 1, wherein the usage environment includes at least a network connecting the client terminal, a communication band able to be used by the client terminal, and specifications of the client terminal.

4. A client terminal comprising:
a detecting unit detecting a usage environment of the client terminal;
a transmitting and receiving unit transmitting input at a client terminal to a server and receiving from the server the results of processing of the server in accordance with the input when it is determined to realize the client terminal as the screen transfer type based on the usage environment detected by said detecting unit and a predetermined policy; and
a downloading unit downloading from the server a program to output results of processing in accordance with input at the client terminal when it is determined to realize the client terminal as the net boot type based on the usage environment detected by the detecting unit and a predetermined policy.

5. The client terminal according to claim 4, further comprising a unit to determine whether to realize the client terminal by the screen transfer type or the net boot type based on the usage environment detected by the detecting unit and a predetermined policy.

6. The client terminal according to claim 4, wherein the usage environment includes at least a network connecting the client terminal, a communication band able to be used by the client terminal, and specifications of the client terminal.

7. A server comprising:
a storing unit storing a boot image to be downloaded to a client terminal when realizing a thin client of a net boot type; and
a working environment providing unit providing the client terminal with a working environment for a thin client of a screen transfer type by loading the boot image stored in the storing unit when realizing the thin client of the screen transfer type.

8. The server according to claim 7 further comprising a unit determining whether to realize the thin client of the screen transfer type or the net boot type based on a usage environment of the client terminal, detected at the client terminal, and a predetermined policy.
